(19) United States
(12) Patent Application Publication
(10) Pub. No.: US 2004/0246588 A1
(43) Pub. Date: Dec. 9, 2004

(54) Portable apparatus for image vision

(76) Inventor: Giorgio Grego, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/477,431

(22) PCT Filed: Apr. 30, 2002
(86) PCT No.: PCT/IT02/00281

(30) Foreign Application Priority Data
May 7, 2001 (IT) T02001A000422

(51) Int. Cl. G02B 27/14

(52) U.S. Cl. 359/630

(57) ABSTRACT

The present invention relates to a portable apparatus for the vision of images comprising a supporting structure (11) to be applied on a user's head substantially in the form of eyeglasses, a display device (13a, 13b) fitted on said structure having a display surface (51-58) on which spatial distributions of light emissions arc generated and a control unit (30) capable of driving the display device (13a, 13b) in order to generate on the display surface (51-58), positioned before the eye, centered on its optical axis at a distance substantially equal to the focal distance of the cornea-lens system, a spatial distribution of light emissions, substantially corresponding to the Fourier transform of the image to be made visible.

### TECHNICAL FIELD

The present invention relates to a portable apparatus for image vision comprising a supporting structure to be applied to a person's head substantially in the form of eyeglasses, a display device mounted on said structure, having a display surface on which spatial distributions of light intensity are generated, and a control unit of the display device.

### Background Art

There already exist portable apparatuses for image vision of the type referred to by the invention, wherein the image to be displayed is formed on the display surface and focussed on the eye retina through an optical system mounted on the supporting structure of the apparatus. Owing to said optical system, these apparatuses have the drawback of being rather heavy and not so pleasing to be worn by a person.

### DISCLOSURE OF THE INVENTION

Object of this invention is to implement a portable apparatus for image vision which does not require an optical system for focussing the image on the retina, and is therefore lighter and more pleasing to be worn by a person.

This object is achieved by a portable apparatus for image vision characterised in that the control unit is capable of controlling the display device in order to generate on its display surface a spatial distribution of light emissions substantially corresponding to the Fourier transform of the image to be made visible.

According to an additional feature of this invention, the apparatus for image vision is characterised in that its control unit comprises means capable of transmitting to the display device, over electromagnetic waves, coded signals corresponding to the Fourier transform of the image to be made visible, and in that such a display device includes means for the reception of said coded signals.

### BRIEF DESCRIPTION OF DRAWINGS

This and other characteristics of the invention will become evident from the following description of a preferred embodiment of the invention made by way of a non-limiting example, with reference to the attached drawing, wherein:

FIG. 1 shows a sketchy perspective view of an optical system illustrating the physical principles on which the invention is based;

FIG. 2 shows a prospective, partially sectioned view of the preferred embodiment of the apparatus for image vision according to the invention;

FIG. 3 shows a partial perspective view of a variation of the preferred embodiment of the apparatus for image vision according to the invention;

FIG. 4 shows a logic block diagram of the preferred embodiment of the apparatus for image vision according to the invention;

FIG. 5 shows a sectional view of a part of the display device of the apparatus for image vision according to the invention.

### BEST MODE FOR CARRYING OUT THE INVENTION

With reference to FIG. 1, it is known from physics (see for instance the book “Optics” by Eugene Hecht, published by Addison Wesley Longman, 3^{rd} Edition 1998, chapter 13) that, given: (a) an optical system formed by a bi-convex lens 1, with optical axis 2, object space 3 and image space 4, and (b) a luminous bi-dimensional picture 5 (for instance, a slit having the shape of said figure, back-lit through a quasi-monochromatic and spatially coherent light) lying on the focal plane 6 of the object space 3, perpendicular to the optical axis 2, and centred with respect to the same, then the spatial distribution of light emission 7 that is produced on the focal plane 8 of the image space 4, perpendicular to the optical axis 2, corresponds to the Fourier Transform of the bi-dimensional spatial distribution of the luminous object 5 (i.e. the Fourier transform of the bi-dimensional spatial distribution of the electromagnetic field associated to the luminous object or of the luminous intensity of said object), which provides the spectrum in both phase and amplitude of the spatial frequencies of said distribution.

It is already known, by virtue of the principle of inversion of optical paths, that reciprocally the image of the spatial distribution of light emissions 7 (meeting intensity and phase of each point of the same) that is generated on the object plane 6, corresponds to the bi-dimensional picture 5.

According to the above physical principles, if lens 1 is the cornea-lens optical system of an eye, and the spatial distribution of light emission 7 is positioned in front of the eye on the focal plane of the cornea-lens system at rest (about 15,6 mm), the image resulting on the retina is the bi-dimensional picture 5.

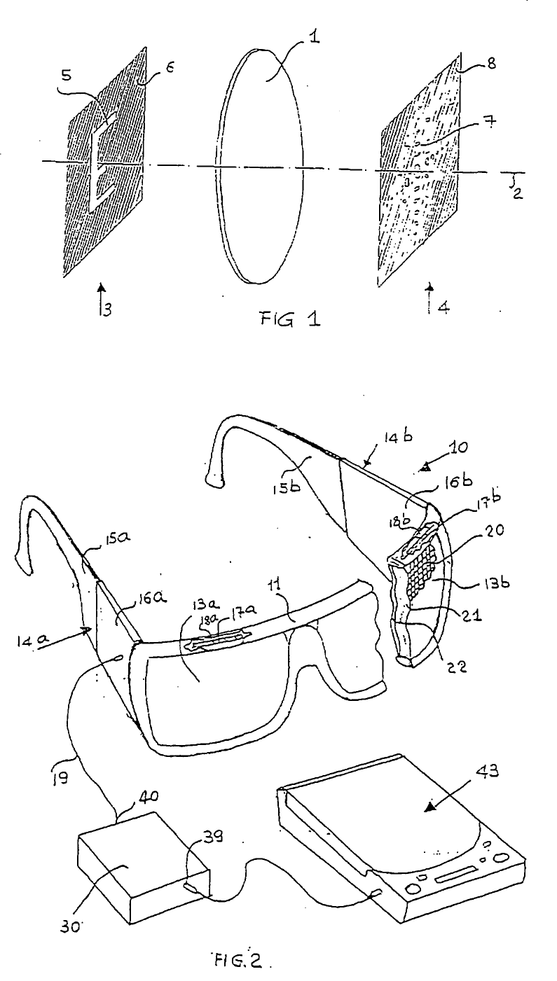

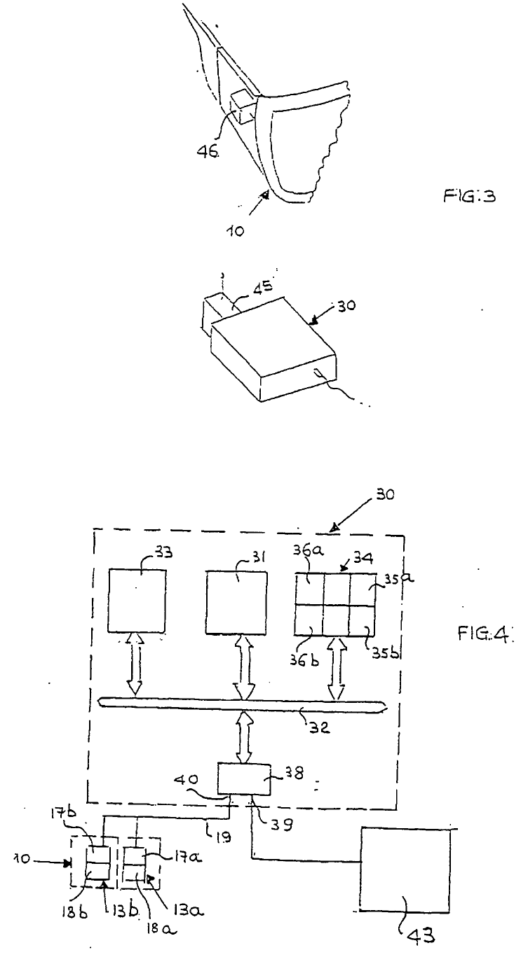

On the basis of the above-mentioned physical principles, according to a preferred embodiment, the portable apparatus for image vision subject matter of the present invention comprises (FIGS. 2 and 4) a viewer 10 designed to be worn by a person in the manner of eyeglasses, and a control unit 30.

The viewer 10 includes a supporting structure 11 substantially in the form of an eyeglass frame, on which (in place of common eye lenses) two colour display devices formed by liquid crystal devices or electro-optical devices, 13a and 13b are mounted. The supporting structure includes two bars, 14a and 14b, which are length-adjustable by shifting their ends 15a and 15b in respect to their parts 16a and 16b, in order to adjust the distance of the display devices 13a and 13b from the eyes of the person wearing the viewer 10

The Liquid Crystal Display Devices (LCD) 13a and 13b are of a known type, called “twisted nematic”, and each of then includes a multi-layer structure subdivided into a bi-dimensional matrix of elemental areas or visualization points (pixel) 20, for each of the fundamental colours red, green and blue.

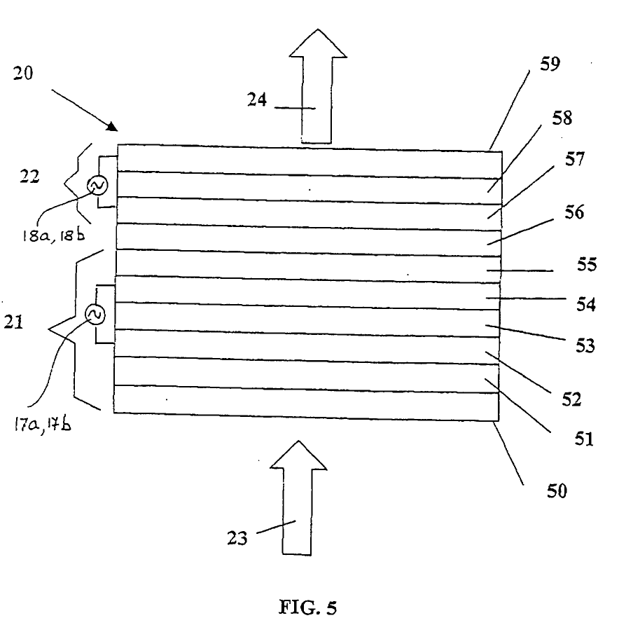

The multi-layer structure of each pixel 20 (FIG. 5) is subdivided in turn, in the direction of its thickness, into two sub-structures 21 and 22, superimposed and separated by a transparent layer 56 of silicon dioxide (SiO₂), having the functions of amplitude modulation (21) and phase modulation (22) of the incident beam 23, respectively. The sub-structure 22 is the one closest to the eye (internal part of the display devices, 13a and 13b).

The amplitude modulation sub-structure 21 comprises a layer of monochromatic filter 50, a layer of light polarisation material 51, a layer of liquid crystals 53 located between two electro-conductive and transparent layers 52 and 54, another light polariser layer 55 with a polarisation plane perpendicular to that of layer 51 and having the function of a polarised light analyser. The layer 53 is suitable to cause the rotation of the polarisation plane of the incident light 23 that crosses it from a minimum of degrees to a maximum of ninety degrees and thus to modulate (from zero to its maximum) the luminous intensity of the light 24 coming out from the sub-structure 21 of pixel 20, as a function of the electric potential difference applied to the electrodes 52 and 54.

The phase modulation sub-structure 22 includes a layer of electro-optical material 58, such as lithium niobate (LiNbO₃) or barium titanate (BaTiO₃), located between two electro-conductive and transparent layers 57 and 59. Layer 58 is capable of varying the propagation velocity of the light beam crossing it (owing to the variation of its refractive index) and therefore the phase of the associated electromagnetic field, as a function of the electric potential difference applied to electrodes 57 and 59.

According to a variation of the above-mentioned pixel structure, instead of liquid crystals, the layer 53 of the amplitude modulation sub-structure 22 can be of electro-optical crystals, such as lithium niobate crystals. In this case the polarisation plane rotation of the light crossing the layer 53, and therefore, the modulation of its luminous intensity, are achieved in a known manner through the bi-refraction induced in the lithium niobate crystals adequately oriented by the voltage applied to the electrodes 52 and 54.

Electrodes 52 and 54, and 57 and 59, respectively, of the pixels 20 of the display devices 13a and 13b are organised in a known manner according to matrix structures, and connected to the corresponding driving devices 17a and 17b, respectively, suitable to drive the amplitude of the light emissions of the pixels, of a known type, and to driving devices suitable to drive the phase of the light emissions of pixels 18a and 18b, respectively, of a known type located in appropriate cavities obtained inside the supporting structure 11.

The control unit 30 includes (FIG. 4) a central processing unit (CPU) 31 of known type, a channel (BUS) 32 for the exchange of data/addresses/commands, controlled by CPU 31, a read-only memory (ROM) 33 of a known type, connected to CPU 31 through the BUS 32, a volatile random access memory (RAM) 34 of a known type, connected to CPU 31 though the BUS 32, and including storage sectors 35a and 35b and 36a and 36b, an input/output control unit (input/output controller) 38 connected to BUS 32 and capable of receiving data through an input port 3° and sending out data through an output port, 40. Driving devices 17a and 17b and 18a and 18b of the viewer 10 are connected over a small cable, 19, to port 40 of control unit 30.

Computer programs, specifically coded in an appropriate programming language, are stored into ROM 33 to control CPU 31 for sequentially carrying out the following functions:

(a) sequential storage into storage sectors 35a and 35b, of the codes (according to known standard coding techniques) of the pixels of corresponding digitised images received at the input port 39;

(b) generation and storage into storage fields 36a and 36b (according to said standard coding techniques) of codes relating to amplitude and phase of the pixels of spatial distributions of digitised light emissions corresponding to the Fourier transforms of the digitised images stored into storage fields 35a and 35b, respectively.

(c) transmission, over port 40, of the amplitude and phase codes of the pixels of the spatial distributions of light emissions, stored into storage fields 36a and 36b to driving circuits 17a and 17b, and 18a and 18b, respectively, in order to control display devices 13a and 13b, respectively, for the creation of corresponding spatial distributions of light emissions over their multi-layer structure 20, as previously described. By way of an example, the function described at previous point (b) can be carried out by means of a program of a known type called “Two Dimensional Fast Fourier Transform” (FFT2D)” (reference may be made, for instance, to the paper “2 Dimensional FFT” by Paul Bourke, July 1998, available via internet at the following site address:

www.swin.edu.au/astronomy/pbourke/analysis/fft2d/ or the on-line text “HPR2 Image Processing Learning Resources” © 2000, Robert Fisher, Simon Perkins, Ashley Walker, Erik Wolfart, available via internet at the following site:

http://www.dai.ed.ac.uk/HIPR2/hipr_top.htm.

The output of any apparatus capable of storing and processing the codes (according to known standard coding techniques) of the pixels of digitised images, such as for instance a reader of digital video disk (DVD) 43 or a note-book (not shown here), can be connected to the input port 39 of the control unit 30.

According to a variation of the embodiment being preferred (FIG. 3) the linking between control unit 30 and driving circuits 17a and 17b, and 18a and 18b, is performed over an electromagnetic wave transceiver 45 of a known type connected to the output 40 of control unit 30, and capable of transmitting radio-signals according to a know transmission protocol, for instance the “Bluetooth” protocol, to a corresponding transceiver 46, of a known type, fitted on the supporting structure 11 and connected to the driving devices 17a, 17b and 18a, 18b.

The operation of the above described portable apparatus for image vision is as follows.

The user wears the viewer 10 like eyeglasses, with layer 59 of the structures 20 of the display devices 13a and 13b, substantially in front of his/her eyes, centred on their optical axis, at a distance substantially equal to the focal distance of the cornea-lens system at rest. When the apparatus for image vision is switched OFF, the viewer 10, works as common, transparent eyeglasses. When the apparatus for image vision and the DVD reader 43 are switched ON and two digitised images, stored on the DVD (an image for each eye For a stereoscopic vision), are read by the reader, the codes of the corresponding pixels are transmitted to the control unit 30, which processes their Fourier transform and then sends to driving devices 17a, 17b and 18a, 18b, of viewer 10 the codes of amplitude and phase, respectively, of the pixels of the two spatial distributions of light emissions that correspond to the Fourier transform of both digitised images mentioned above.

These distributions are generated in the multi-layer structure 20 of the display devices 13a and 13b of viewer 10 and, for the physical principle mentioned previously with reference to FIG. 1, through the cornea-lens system of the eyes, they create on the retina images corresponding to those digitised and stored on the video CD.

Should the vision by the user not be sharp enough, he/she can adjust the distance of devices 13a and 13b from the eyes by varying the length of the bars 14a and 14b, as previously described, so as to achieve a sharp vision.

According to another embodiment of the present invention, instead of the specific, ad hoc control unit 30, use is envisaged of the control unit making part of a standard portable computer, equipped with a DVD reader 10 (i.e. a note-book) In such a case, all the hardware components (CPU, ROM, RAM, BUS, Input/Out controller) of the control unit 30 are those typical of a common configuration of a note-book, whereas the above-described FFT2D program is stored on the hard disk unit (HDU) of the note-book, and the viewer 10 is linked to the serial output of the note-book, like an external display of the same.

According to another embodiment of the present invention, the viewer 10 is directly connected to the output of the DVD reader. In such a case the DVDs read by the reader must store codes of the pixels of the Fourier transforms relating to the digitised images to be made visible.

The storage of such codes can be performed beforehand in a known manner through a standard note-book equipped with a DVD master unit (masterizzatore) and a FFT2D program.

It is clear that implementation details and practical embodiments of the description may be varied as far as dimensions, shapes, materials, components, circuit elements, connections and contacts, or details relating to the circuit layouts, to the execution herein illustrated and its method of operation, however without departing from the scope of the invention, as disclosed in the following claims.

1. Portable apparatus for image vision (10), comprising a supporting structure (11) designed to be applied to a user's head substantially in the form of eyeglasses, a display device (13a, 13b) mounted on said structure (11) having a display surface (51-58) on which spatial distributions of light emissions are created, a control unit (30) of said display device (13a, 13b) capable of driving said display device (13a, 13b) to generate on its display surface (51-58) a spatial distribution of light emission substantially corresponding to the Fourier transform of the image to be made visible, characterised in that said display device (13a, 13b) is fitted on said structure (11) in such a way that, when said structure (11) is applied to a person's head, said display surface (51-58) is positioned before the eye, centered on its optical axis, at a distance substantially equal to the focal distance of the cornea-lens system at rest.

2. Portable apparatus (10) according to claim 1, characterised in that said control unit (30) comprises reception means (38) capable of receiving at an input (39) a digitised form of the image to be made visible, processing means (31) capable of creating a digitised form of the Fourier transform of said digitised form of the image to be made visible, and transmission means (40) capable of transmitting said digitised form of the Fourier transform to the display device (13a, 13b).

3. Portable apparatus (10) according to claim 2, characterised in that said transmission means (40) are capable of transmitting coded signals over electromagnetic waves and in that said display device (13a, 13b) comprises corresponding reception means for receiving said coded signals.

4. Portable apparatus (10) according to claim 1 characterised in that said display device (13a, 13b) comprises display means made of liquid crystals.

5. Portable apparatus (10) according to claim 1 characterised in that said display device (13a, 13b) comprises display means made of electro-optical crystals.

6. Portable apparatus (10) according to claim 1 characterised in that said display device (13a, 13b) is subdivided into elemental zones (pixels) and comprises means for modulating the amplitude of the light emission of each of said elemental zones.

7. Portable apparatus (10) according to claim 6 characterised in that said display device comprises means for modulating the phase of the light emission of each of said elemental zones.

8. Portable apparatus (10) according to claim 1 characterised in that said supporting structure (11) comprises adjusting means (15a, 15b, 16a, 16b) for adjusting the distance of the display device (13a, 13b) from the eyes.
